(19) United States
(12) Patent Application Publication
(10) Pub. No.: US 2025/0139420 A1
(43) Pub. Date: May 1, 2025

(54) ADAPTIVE SAMPLING FOR EQUIVARIANT MACHINE LEARNING MODELS

(71) Applicant: QUALCOMM Technologies, Inc., San Diego, CA (US)

(72) Inventors: Berfin INAL, Diemen (NL); Gabriele CESA, Diemen (NL)

(21) Appl. No.: 18/494,910

(22) Filed: Oct. 26, 2023

(51) Int. Cl. G06N 3/048

(52) U.S. Cl. CPC G06N 3/048

(57) ABSTRACT

Certain aspects of the present disclosure provide techniques and apparatus for improved machine learning. A feature tensor generated based on a model input to a machine learning model is accessed. A sampling matrix is generated based on the model input. An activation output is generated using an activation layer of the machine learning model based on the feature tensor and the sampling matrix, and the activation output is provided as output from the activation layer of the machine learning model.

### INTRODUCTION

Aspects of the present disclosure relate to machine learning.

A wide variety of machine learning model architectures have proliferated and have been used to provide solutions for a multitude of prediction problems. For example, convolutional neural networks (CNNs) have been used in recent years to process images in order to perform a variety of tasks, such as object recognition, image classification, and the like. A wide variety of common model inputs, such as images and other representations of natural (e.g., real) objects and structures (e.g., image data, point cloud data, and the like), often exhibit geometrical symmetries of various types, such as rotational symmetry and reflective symmetry. Some conventional machine learning models (e.g., CNNs) exhibit or enable translation symmetry, where an input feature (e.g., a depiction of a flower) may be translated or located in any region of the input image without affecting the model output. That is, some conventional models are able to accurately identify the flower, regardless of whether the flower is depicted in the center of the image, the left side of the image, the right side of the image, and the like. However, some conventional models fail to exhibit other more complex symmetries, such as rotational or reflective symmetries. As a result, applying such symmetries to the input of some conventional models leads to unpredictable differences in the output.

Further, some conventional approaches to enable equivariant behavior rely on discrete sampling (e.g., random sampling) from a group of potential symmetries during training. Generally, using more random samples results in more stable (and more equivariant) models. However, such conventional sampling introduces substantial computational expense.

### BRIEF SUMMARY

Certain aspects of the present disclosure provide a processor-implemented method, comprising: accessing a first feature tensor generated based on a model input to a machine learning model; generating a sampling matrix based on the model input; generating a first activation output using a first activation layer of the machine learning model based on the first feature tensor and the sampling matrix; and providing the first activation output as output from the first activation layer of the machine learning model.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts an example workflow for adaptive sampling for equivariant non-linear operations in machine learning models, according to some aspects of the present disclosure.

FIG. 2 depicts an example adaptively generated sampling matrix and activation operation in machine learning models, according to some aspects of the present disclosure.

FIG. 3 depicts an example architecture for adaptive sampling to enable equivariant machine learning models, according to some aspects of the present disclosure.

FIG. 4 is a flow diagram depicting an example method for adaptive sampling in equivariant models, according to some aspects of the present disclosure.

FIG. 5 is a flow diagram depicting an example method for generating activation output using adaptive sampling matrices, according to some aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved equivariant machine learning models using adaptive sampling.

In some aspects, rather than relying on discrete equivariance or random sampling during training (as is used in some conventional architectures), sampling matrices can be dynamically generated based on input data to improve equivariance with reduced computational expense. For example, some conventional approaches to enable model equivariance provide equivariance only for a discrete and finite set of transformations used during training, rather than for continuous transformations (e.g., only for discrete rotations, rather than continuous rotation amounts). Further, some conventional approaches to approximate continuous equivariance use random sampling from the continuous transformation space during training, but such random sampling relies on a large number of samples to better approximate equivariant behavior, resulting in substantial expense.

In some aspects of the present disclosure, rather than restricting equivariance to discrete transformations or relying on random sampling, adaptive or dynamic generation of sampling matrices can be used to improve model stability and equivariance while reducing computational expense. In some aspects, dynamic sampling is provided by generating the sampling matrices based at least in part on the input to the model itself. As used herein, generating the sampling matrix based on the model input can include processing the input itself using a sampling branch of the model, and/or using the sampling branch to process a set of features that were generated (e.g., by a prior layer) based on the model input.

In some aspects, steerable CNNs are used to provide equivariance in machine learning. Steerable CNNs generally define feature spaces as spaces of steerable feature fields, where the feature fields are associated with a transformation law of a corresponding transformation group G (e.g., rotations and reflections across or around one or more axes). As used herein, irreducible representations (irreps) (sometimes designated as w) refer to the simplest indivisible representation of a group G. Irreps may be thought of as breaking down functions over the group elements into indivisible components, in a similar way to the sinusoids in a Fourier transform. Generally, the intermediate features of steerable CNNs transform according to the irreps of the group G. These steerable features can therefore be interpreted as Fourier coefficients for functions over the group G. Using inverse Fourier transforms on the features can therefore enable pointwise nonlinearities (e.g., in activation layers) to be applied.

Specifically, in some aspects, sampling of the group elements is performed in non-linear activation layers of a convolutional neural network. Such non-linear layers may be defined by a sequence of operations. First, a discretized inverse Fourier transform is performed on the features provided as input to the non-linear layer. In aspects of the present disclosure, adaptive sampling is used in this step, as discussed in more detail below. Pointwise non-linearity (e.g., using an activation function such as a rectified linear unit (ReLU)) can then be applied to the transformed features. A discretized Fourier transform can then be applied to transform the output of the nonlinearity operation back to Fourier coefficients.

As used herein, adaptive sampling (also referred to dynamic sampling) generally refers to generating the sampling matrix (used to sample the group, as discussed in more detail below) by processing model input (or intermediate features generated based on the model input) using a set of learned parameters (e.g., parameters having values learned during training), rather than using random or fixed sampling matrices. In some aspects, by using adaptive sampling for activation layers of a CNN, equivariance to a continuous transformation group G can be achieved using substantially fewer samples and computational resources, as compared to some conventional approaches.

### Example Workflow for Adaptive Sampling for Equivariant Non-Linear Operations in Machine Learning Models

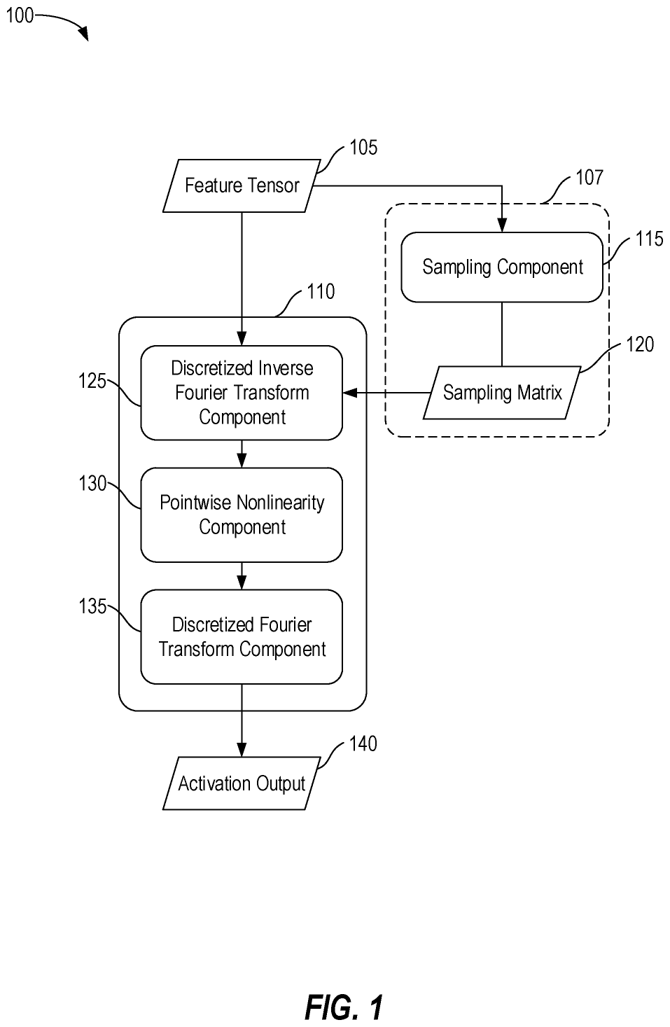

FIG. 1 depicts an example workflow 100 for adaptive sampling for equivariant non-linear operations in machine learning models, according to some aspects of the present disclosure. In some aspects, the workflow 100 is performed by a machine learning system (e.g., a computing system) as part of processing data using a machine learning model. For example, the illustrated workflow 100 may correspond to processing feature data using a nonlinear operation in a CNN.

In the illustrated example, a feature tensor 105 is accessed as input to a nonlinear block 110. As used herein, “accessing” data can generally include receiving, retrieving, requesting, collecting, generating, or otherwise gaining access to the data. The feature tensor 105 (sometimes referred to as an intermediate feature tensor) may generally correspond to any data that may be provided as input to a nonlinear operation in a machine learning model (e.g., a CNN). For example, the feature tensor 105 may be generated by a layer (e.g., a convolution operation) in the model. In some aspects, as discussed above, the model is a steerable CNN, and the feature tensor 105 may correspond to or comprise a set of Fourier coefficients.

In the illustrated workflow 100, the feature tensor 105 is also accessed by a sampling branch 107. The sampling branch 107 generally corresponds to one or more operations or components of the machine learning model that are used to dynamically generate sampling matrices based on model input. As used herein, generating the sampling matrix based on model input may correspond to processing the model input directly using the sampling branch 107, or to processing an intermediate feature (such as the feature tensor 105), which was generated based on model input, using the sampling branch 107. Further, although the illustrated example depicts the same feature tensor 105 being used as input to both the nonlinear block 110 and the sampling branch 107, in some aspects, the sampling branch 107 may access a different input. For example, while the nonlinear block 110 processes the feature tensor 105 generated by the immediately prior layer, the sampling branch 107 may use a different intermediate feature (e.g., generated by an earlier layer in the model).

As illustrated, the feature tensor 105 is processed by a sampling component 115 to generate a sampling matrix 120. The sampling component 115 may generally correspond to a wide variety of operations, and generally uses a set of learned parameters (e.g., parameters having values learned during training) to generate the sampling matrix 120 based on the feature tensor 105. For example, in some aspects, the sampling component 115 comprises a multilayer perceptron (MLP). In other aspects, the sampling component 115 comprises one or more convolutional layers. In some aspects, the sampling component 115 performs equivariant transformation on the feature tensor 105. That is, the sampling component 115 may be an equivariant MLP, an equivariant convolutional layer, and the like.

In the illustrated example, the sampling matrix 120 is used by the nonlinear block 110 to process the input feature tensor 105. In some aspects, a single sampling matrix 120 can be generated based on input data, and used by each nonlinear block in the model. In some aspects, the sampling branch 107 may generate a different sampling matrix 120 for each nonlinear block (or multiple sampling branches may be used), such as by processing different input features and/or by using different learned parameters to generate the sampling matrix for each nonlinear block.

As illustrated, the nonlinear block 110 generally comprises a discretized inverse Fourier transform component 125, a pointwise nonlinearity component 130, and a discretized Fourier transform component 135. Although depicted as discrete components or operations for conceptual clarity, in some aspects, the operations of the discretized inverse Fourier transform component 125, the pointwise nonlinearity component 130, and the discretized Fourier transform component 135 may be combined or performed by a single component, as discussed in more detail below, or may be distributed among any other number of components.

In the depicted workflow 100, the discretized inverse Fourier transform component 125 accesses the feature tensor 105 (e.g., the input to the nonlinear block 110) and the sampling matrix 120 (generated by the sampling component 115 of the sampling branch 107) to generate a first intermediate tensor that is used as input to the pointwise nonlinearity component 130. In some aspects, the discretized inverse Fourier transform component 125 uses the sampling matrix 120 to generate the first intermediate tensor.

In some aspects, the discretized inverse Fourier transform component 125 may perform an inverse Fourier transform function defined using Equation 1 below, where f(x) is the first intermediate tensor generated based on model input x (e.g., based on the data used as input to the model itself), A(x) is the sampling matrix 120 generated based on the input x (which may include generating the sampling matrix 120 based on processing model input x using the sampling branch 107, and/or based on processing the feature tensor 105 using the sampling branch 107), and \hat{f}(x) is the feature tensor 105 (e.g., generated based on model input x).

$$f ( x ) = A ( x ) \hat{f} ( x ) \qquad ( 1 )$$

In the illustrated example, the first intermediate tensor is processed by the pointwise nonlinearity component 130 to generate a second intermediate tensor, which is used as input to the discretized Fourier transform component 135. The pointwise nonlinearity component 130 generally includes any nonlinear function (e.g., an activation function), such as ReLU, an exponential linear unit (ELU), and the like. That is, the first intermediate tensor is processed using the activation function (by the pointwise nonlinearity component 130) to generate the second intermediate tensor. In some aspects, the second intermediate tensor may be defined as σ(f(x)), where σ indicates application of a nonlinear function (e.g., ReLU). Combined with Equation 1 above, therefore, the second intermediate tensor may be defined as σ(A(x)\hat{f}(x)).

In some aspects, the discretized Fourier transform component 135 processes the second intermediate tensor to generate the activation output 140 for the nonlinear block 110. In some aspects, the activation output 140 is defined using Equation 2 below, where \hat{f}(x) is the activation output 140 and A(x)⁺ is the pseudoinverse of the matrix A(x). In some aspects, A(x)⁺=(A(x)^{T}A(x))⁻¹A(x)^{T}.

$$\tilde{f} ( x ) = {A ( x )}^{+} σ ( A ( x ) \hat{f} ( x ) ) \qquad ( 2 )$$

In some aspects, as computing the inverse of (A(x)^{T}A(x))⁻¹ (to compute A(x)⁺) may be computationally expensive during a forward pass through the model (as well as being difficult to backpropagate through on a backward pass), A(x)⁺ is approximated as

$${A ( x )}^{+} \approx \frac{1}{n} {A ( x )}^{T} ,$$

where n is the number of rows in the sampling matrix 120. In some aspects, therefore, the output of the discretized Fourier transform component 135 may be defined using Equation 3 below.

$$\tilde{f} ( x ) = \frac{1}{n} {A ( x )}^{T} σ ( A ( x ) \hat{f} ( x ) ) \qquad ( 3 )$$

In some aspects, as discussed above, the operations of the discretized inverse Fourier transform component 125, the pointwise nonlinearity component 130, and the discretized Fourier transform component 135 may be combined or performed by a single component. For example, rather than first computing a first intermediate tensor (using the discretized inverse Fourier transform component 125), then computing a second intermediate tensor (using the pointwise nonlinearity component 130), and then computing the activation output 140 (using the discretized Fourier transform component 135), the nonlinear block 110 may be implemented as a single operation to generate a single tensor, such as by processing the input feature tensor 105 and the sampling matrix 120 using Equation 3 directly.

In some aspects, as discussed above, use of the dynamically generated sampling matrix 120 can substantially improve the stability and equivariance of the nonlinear block 110, while significantly reducing computational expense, as compared to some conventional approaches that rely on large numbers of samples. In some aspects, the workflow 100 may be used both during training of the network (e.g., to generate model output during the forward pass) as well as during inferencing using the network.

The activation output 140 may be used for a variety of purposes, depending on the particular architecture. For example, in some aspects, the activation output 140 is used as input to a subsequent layer or operation of the model (e.g., to a subsequent convolution layer), or may be used as the output of the model.

### Example Adaptively Generated Sampling Matrix and Activation Operation in Machine Learning Models

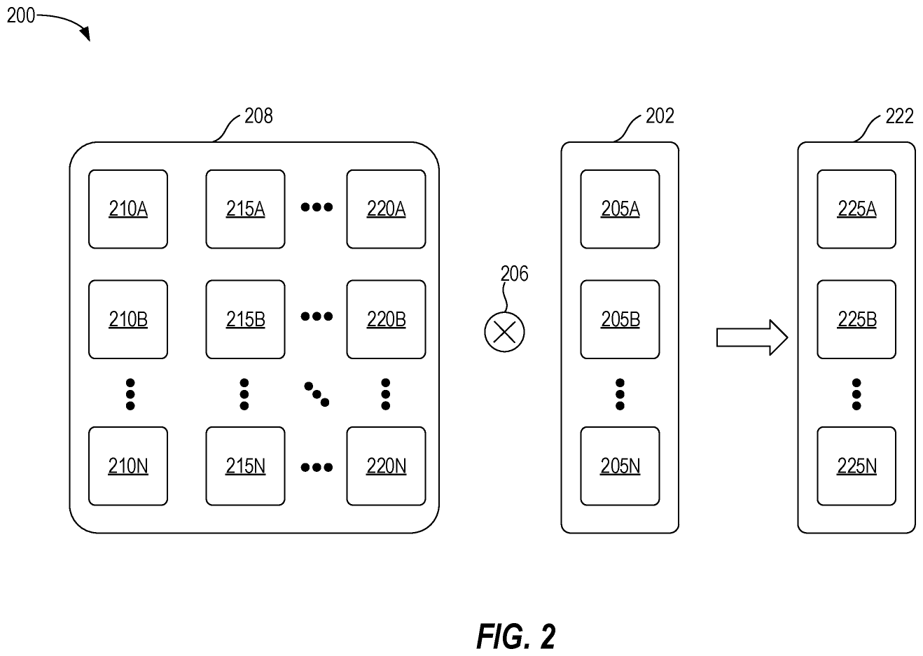

FIG. 2 depicts an example adaptively generated sampling matrix and operation 200 in machine learning models, according to some aspects of the present disclosure. In some aspects, the operation 200 corresponds to the discretized inverse Fourier transform used in a nonlinear block (e.g., performed by the discretized inverse Fourier transform component 125 of FIG. 1).

In the illustrated example, the tensor 202 (which may correspond to a feature tensor, such as the feature tensor 105 of FIG. 1, used as input to a nonlinear block) is a vector of Fourier coefficients. That is, each of the elements 205A-205N (collectively, elements 205) may be Fourier coefficients. The sampling matrix 208 (which may correspond to the sampling matrix 120 of FIG. 1) is a matrix of elements 210A-N, 215A-N, and 220A-M, where each column in the sampling matrix 208 corresponds to or represents a respective irrep of the transformation group to which the nonlinear block is equivariant. That is, elements 210A, 210B, and 210N may correspond to a first irrep, elements 215A, 215B, and 215N may correspond to a second irrep, and so on. In some aspects, the set of irreps is finite (e.g., the sampling matrix 208 has a finite number of columns).

In some aspects, each row in the sampling matrix 208 corresponds to or represents a respective group element from the transformation group to which the nonlinear block is equivariant. In some aspects, there may be any number of columns and any number of rows in the sampling matrix 208, depending on the particular implementation.

In the illustrated example, the tensor 202 and sampling matrix 208 are aggregated or processed using operation 206 (e.g., a multiplication operation) to generate the tensor 222. In some aspects, the tensor 222 (having elements 225A-N) corresponds to the first intermediate tensor discussed above with reference to FIG. 1. That is, the tensor 222 may be a vector corresponding to f(x), as discussed above.

In some conventional architectures, as discussed above, the sampling matrix is static during training. For example, a predefined number of group elements may be sampled and cached to form the sampling matrix (e.g., where each sampled group element is used to form a row of the sampling matrix). As discussed above, such conventional approaches generally rely on a large number of samples (e.g., a large number of rows) to yield acceptable results. However, by training the sampling branch and allowing the model to learn to dynamically generate the sampling matrix 208, equivalent (or improved) equivariance and prediction performance can be achieved using substantially fewer samples (and therefore significantly reduced computational expense).

### Example Architecture for Adaptive Sampling to Enable Equivariant Machine Learning Models

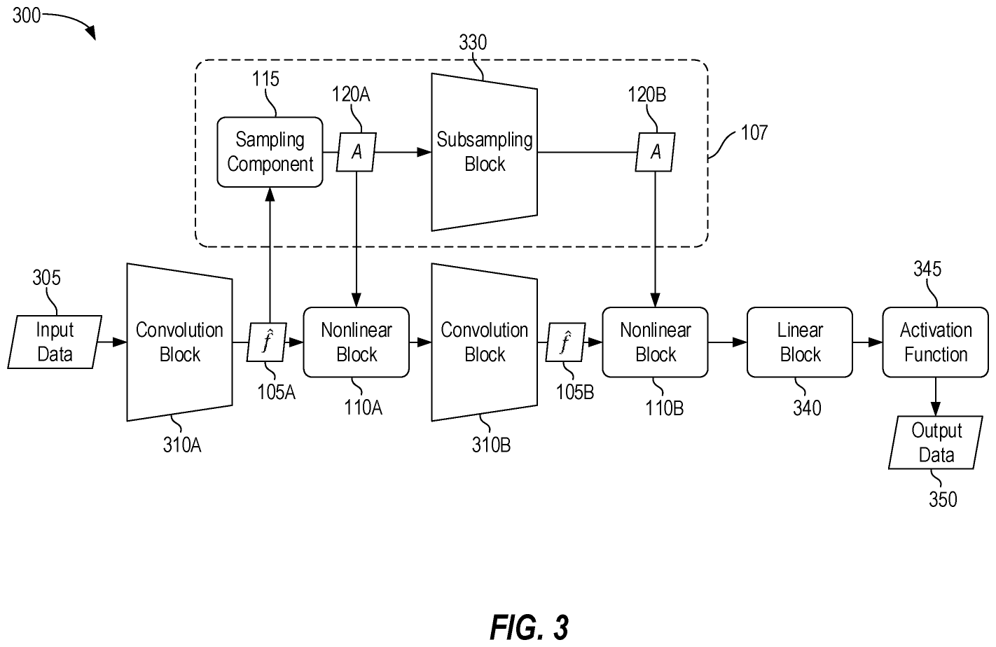

FIG. 3 depicts an example architecture 300 for adaptive sampling to enable equivariant machine learning models, according to some aspects of the present disclosure. In some aspects, the architecture 300 is used by a machine learning system (e.g., a computing system), such as the machine learning system discussed above with reference to FIGS. 1-2.

In the illustrated example, input data 305 is used as input to a machine learning model (e.g., a steerable CNN). In some aspects, the input data 305 is a point cloud (e.g., representing light detection and ranging (LIDAR) data). In some aspects, for each respective element in the input data 305 (e.g., each point in a point cloud), the architecture 300 may generate a different respective sampling matrix.

In the illustrated example, the input data 305 is provided to a first convolution block 310A, which acts as the first layer of the model. In some aspects, the convolution block 310A is an equivariant convolution layer. As illustrated, the convolution block 310A generates a first feature tensor 105A (which may correspond to the feature tensor 105 of FIG. 1) by applying one or more convolution operations to the input data 305. For example, the convolution block 310A may apply one or more equivariant convolution kernels to generate the feature tensor 105A. In some aspects, as discussed above, the feature tensor 105A may represent or be conceptualized as a set of Fourier coefficients.

As illustrated, the feature tensor 105A is provided as input to the sampling branch 107, as discussed above. The sampling branch 107 comprises a sampling component 115 and a subsampling block 330. As discussed above, the sampling component 115 (e.g., an MLP and/or a convolution layer) processes the feature tensor 105A to generate a sampling matrix 120A. The sampling matrix 120A, along with the feature tensor 105A, are then provided as input to a nonlinear block 110A. In some aspects, as discussed above, the nonlinear block 110A applies an activation function (e.g., ReLU) to the feature tensor 105A based in part on the sampling matrix 120A. For example, the nonlinear block 110A may use Equation 3 above to generate activation output.

As illustrated, the activation output is provided to a convolution block 310B (e.g., a subsequent convolution layer in the model). In a similar fashion to the convolution block 310A, the convolution block 310B may generally perform an equivariant convolution operation on the activation output (e.g., using equivariant convolution kernels having learned values) to generate a new feature tensor 105B. The feature tensor 105B is then provided to a second nonlinear block 110B.

In the illustrated example, the sampling matrix 120A (generated by the sampling component 115 and used by the nonlinear block 110A) is also processed by a subsampling block 330 (referred to in some aspects as a downsampling block or operation) to generate a sampling matrix 120B (referred to in some aspects as a downsampled or subsampled sampling matrix). The subsampling block 330 can generally perform any suitable downsampling operation to reduce the dimensionality or size of the sampling matrix 120A. For example, to downsample the sampling matrix 120A, the subsampling block 330 may use linear interpolation, a convolution operation using learned weights, and the like. In some aspects, the subsampling block 330 is used to downsample the sampling matrix 120A to account for subsampling performed by the convolution blocks 310 of the network. That is, if the convolution block(s) 310A and/or 310B reduce the size of the tensors (e.g., if the feature tensor 105B is smaller or has reduced dimensionality, as compared to the feature tensor 105A), the subsampling block 330 may be used to provide corresponding downsampling on the sampling matrix 120A.

In the illustrated example, the sampling matrix 120B is used as input to the nonlinear block 110B. As discussed above, the nonlinear block 110B generally applies an activation function (e.g., ReLU) to the feature tensor 105B based in part on the sampling matrix 120B. For example, the nonlinear block 110B may use Equation 3 above to generate activation output.

In the illustrated example, the activation output generated by the nonlinear block 110B is used as input to a linear block 340 (e.g., a fully connected layer), which generates an intermediate tensor that is provided as input to an activation function 345 (e.g., a softmax function). The activation function 345 generates output data 350 (e.g., an output of the machine learning model). Generally, the particular operations of the activation function 345 may vary depending on the particular implementation (e.g., depending on whether categorical or continuous output is desired). Similarly, the particular format and content of the output data 350 may vary depending on the particular implementation. For example, if the input data 305 is a point cloud, the output data 350 may include a prediction for each point (e.g., a classification or value for each point), a prediction for multiple points (e.g., a classification or value for the entire point cloud), and the like.

Although the illustrated example depicts two convolution blocks 310 for conceptual clarity, there may be any number of convolution blocks in the architecture 300, depending on the particular implementation. Similarly, in some aspects, one or more components (e.g., the linear block 340 and/or the activation function 345) may be omitted.

In the illustrated example, the sampling matrices 120A and 120B are generated based on the feature tensor 105A. In some aspects, each nonlinear block 110 may use different inputs and/or a different sampling component 115 (with different weights). For example, in some aspects, the sampling matrix 120B used by the nonlinear block 110B may be generated based on the feature tensor 105B, rather than the feature tensor 105A.

In some aspects, as discussed above, the depicted operations may be performed during training and/or inferencing using the architecture 300. For example, during training, the input data 305 may be a training sample during the forward pass. The output data 350 may then be compared against a ground truth label for the input data 305 to generate a loss, which can then be used to refine or update the parameters of the model, such as via backpropagation (e.g., using stochastic gradient descent for each sample of input data 305 and/or using batch gradient descent based on multiple input samples). For example, the loss may be used to update the parameters of the linear block 340, the convolution blocks 310, the subsampling block 330, and/or the sampling component 115. Similarly, during inferencing (e.g., after training), the input data 305 may be any input that is being processed to generate a desired output during runtime.

As discussed above, by dynamically generating the sampling matrices 120 based on the input data 305, the architecture 300 can provide improved equivariance and stability with fewer samples and reduced computational expense, as compared to some conventional approaches.

### Example Method for Adaptive Sampling in Equivariant Models

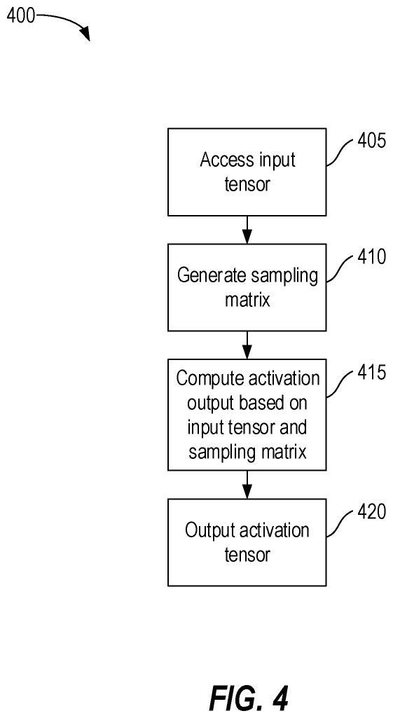

FIG. 4 is a flow diagram depicting an example method 400 for adaptive sampling in equivariant models, according to some aspects of the present disclosure. In some aspects, the method 400 is performed by a machine learning system (e.g., a computing system), such as the machine learning system discussed above with reference to FIGS. 1-3.

At block 405, the machine learning system accesses an input tensor. In some aspects, the input tensor is a feature tensor used as input to a nonlinear operation or layer (e.g., the nonlinear block 110 of FIGS. 1 and/or 3) in a CNN. For example, the input tensor may correspond to the feature tensor 105 of FIGS. 1 and/or 3. In some aspects, the input tensor may correspond to a tensor generated by a component of the model, or may correspond to the input to the model itself.

At block 410, the machine learning system generates a sampling matrix based on the input tensor. For example, the machine learning system may process the input tensor using a sampling component (such as the sampling component 115 of FIGS. 1 and/or 3) of a sampling branch (such as the sampling branch 107 of FIGS. 1 and/or 3). In some aspects, as discussed above, the sampling component may generally correspond to or use a set of trained parameters having values learned based on training data (e.g., using backpropagation) during training of the model.

At block 415, the machine learning system computes an activation output (e.g., the activation output 140 of FIG. 1) for the nonlinear block based on the input tensor and the sampling matrix. For example, as discussed above, the machine learning system may use Equation 2 and/or Equation 3 to generate the activation output.

At block 420, the machine learning system outputs the activation tensor to a subsequent component. For example, the activation tensor may be provided as input to a downstream component of the model (e.g., a convolution layer or a fully connected layer), or may be output from the model as model output.

The method 400 may generally be performed for each equivariant nonlinear block in the machine learning model. In some aspects, as discussed above, the machine learning system may use the same input tensor to generate each sampling matrix for each nonlinear block, or may use a different feature tensor and/or use a different set of sampling parameters to process the feature tensor for each nonlinear block.

As discussed above, by dynamically generating the sampling matrix based on the input tensor, the machine learning system can provide improved equivariance and stability with fewer samples and reduced computational expense, as compared to some conventional approaches.

### Example Method for Generating Activation Output Using Adaptive Sampling Matrices

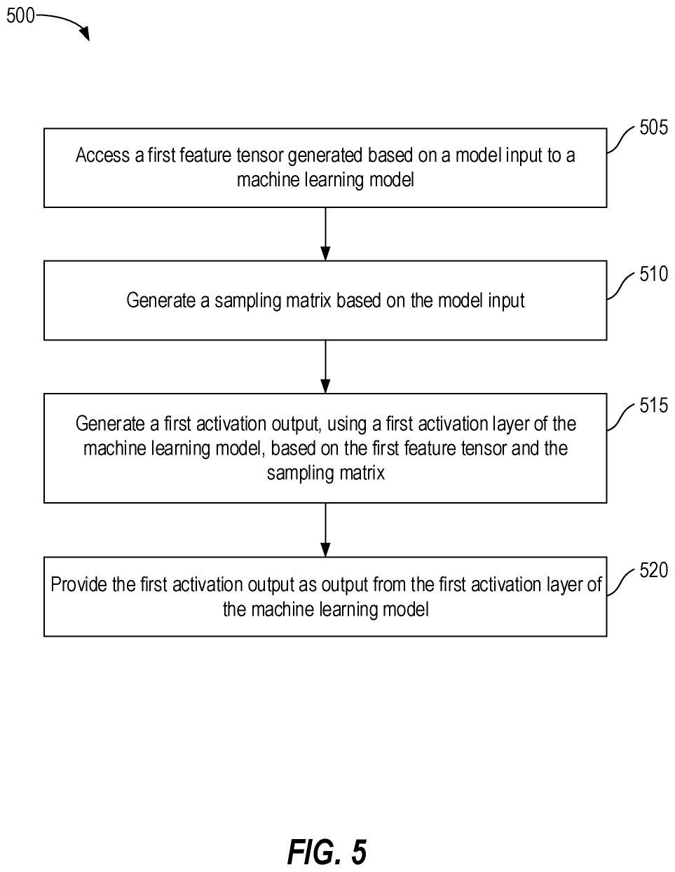

FIG. 5 is a flow diagram depicting an example method 500 for generating activation output using adaptive sampling matrices, according to some aspects of the present disclosure. In some aspects, the method 500 is performed by a machine learning system (e.g., a computing system), such as the machine learning system discussed above with reference to FIGS. 1-4.

At block 505, a first feature tensor generated based on a model input to a machine learning model is accessed.

At block 510, a sampling matrix is generated based on the model input.

In some aspects, the sampling matrix is generated using a set of parameters having values learned during training of the machine learning model. In some aspects, the set of parameters corresponds to at least one of (i) an equivariant multilayer perceptron (MLP) or (ii) an equivariant convolutional layer.

In some aspects, the sampling matrix comprises a respective column for each respective irreducible representation (irrep) of a set of irreps of a transformation group to which the first activation layer of the machine learning model is equivariant.

At block 515, a first activation output is generated using a first activation layer of the machine learning model based on the first feature tensor and the sampling matrix.

In some aspects, the first feature tensor comprises Fourier coefficients generated by a first layer of the machine learning model. In such cases, the sampling matrix may be used to perform an inverse Fourier transform operation on the first feature tensor.

In some aspects, the activation output is generated according to

$$\tilde{f} ( x ) = \frac{1}{n} {A ( x )}^{T} σ ( A ( x ) \hat{f} ( x ) )$$

where \tilde{f}(x) is the activation output for the first feature tensor generated based on the model input, x is the model input, n indicates a number of rows in the sampling matrix, A(x) is the sampling matrix generated based on the first feature tensor, and \hat{f}(x) is the first feature tensor.

At block 520, the first activation output is provided as output from the first activation layer of the machine learning model.

In some aspects, the method 500 further includes generating a second feature tensor based on processing the first activation output using a second layer of the machine learning model, generating a downsampled sampling matrix based on processing the sampling matrix using a downsampling operation of the machine learning model, and generating a second activation output using a second activation layer of the machine learning model based on the second feature tensor and the downsampled sampling matrix.

In some aspects, the downsampling operation comprises at least one of: (i) a linear interpolation operation or (ii) a convolution operation using one or more learned weights.

In some aspects, the method 500 further includes generating a respective sampling matrix for each of a plurality of points in the model input, wherein the model input comprises point cloud data.

### Example Processing System for Machine Learning

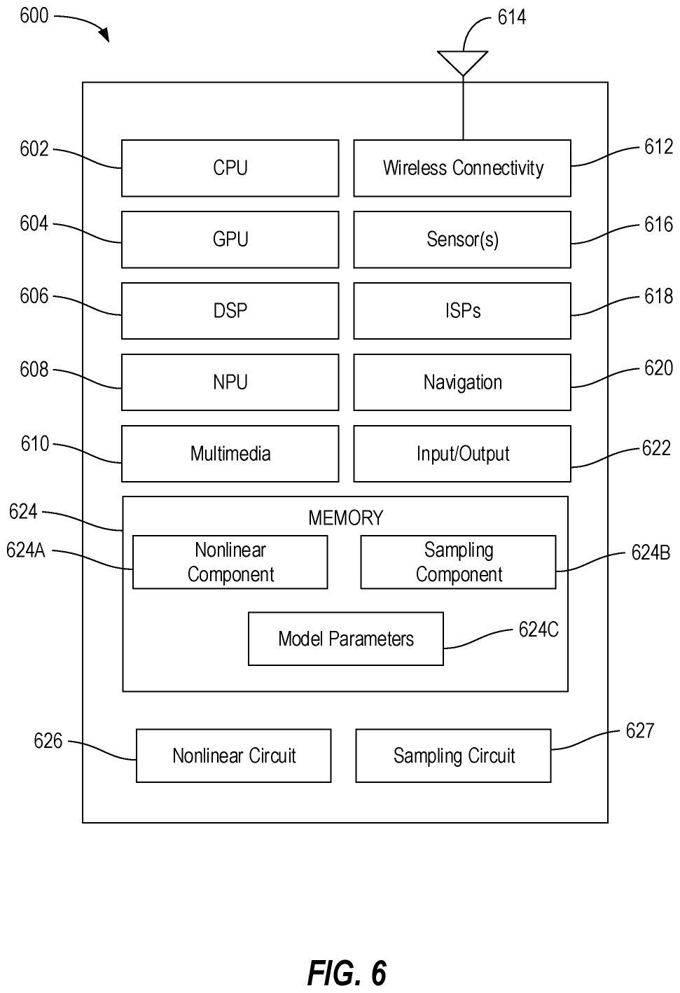

In some aspects, the workflows, techniques, and methods described with reference to FIGS. 1-5 may be implemented on one or more devices or systems. FIG. 6 depicts an example processing system 600 configured to perform various aspects of the present disclosure, including, for example, the techniques and methods described with respect to FIGS. 1-5. In some aspects, the processing system 600 may correspond to a machine learning system. For example, the processing system 600 may correspond to a device that trains and/or uses equivariant machine learning models, as discussed above. Although depicted as a single system for conceptual clarity, in some aspects, as discussed above, the operations described below with respect to the processing system 600 may be distributed across any number of devices or systems.

The processing system 600 includes a central processing unit (CPU) 602, which in some examples may be a multi-core CPU. Instructions executed at the CPU 602 may be loaded, for example, from a program memory associated with the CPU 602 or may be loaded from a memory partition (e.g., a partition of memory 624).

The processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as the NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 608 is a part of one or more of the CPU 602, GPU 604, and/or DSP 606.

In some examples, the wireless connectivity component 612 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes a nonlinear component 624A and a sampling component 624B, as well as a set of model parameters 624C (e.g., parameters of the convolution blocks 310 and/or the linear block 340 of FIG. 3). Although not depicted in the illustrated example, the memory 624 may also include other data such as training data. Though depicted as discrete components for conceptual clarity in FIG. 6, the illustrated components (and others not depicted) may be collectively or individually implemented in various aspects.

The processing system 600 further comprises a nonlinear circuit 626 and a sampling circuit 627. The depicted circuits, and others not depicted, may be configured to perform various aspects of the techniques described herein.

In some aspects, the nonlinear component 624A and/or the nonlinear circuit 626 (which may correspond to the nonlinear block(s) 110 of FIGS. 1 and 3) may be used to perform equivariant nonlinear (e.g., activation) operations in machine learning models, as discussed above. For example, the nonlinear component 624A and/or the nonlinear circuit 626 may use dynamically generated sampling matrices to process intermediate tensors using nonlinear functions.

In some aspects, the sampling component 624B and/or the sampling circuit 627 (which may correspond to the sampling branch 107 of FIGS. 1 and 3) may be used to dynamically generate sampling matrices, as discussed above. For example, the sampling component 624B and/or the sampling circuit 627 may use learned parameters to generate sampling matrices based on input data, and provide these sampling matrices to nonlinear layer(s) for processing.

Though depicted as separate components and circuits for clarity in FIG. 6, the nonlinear circuit 626 and the sampling circuit 627 may collectively or individually be implemented in other processing devices of the processing system 600, such as within the CPU 602, GPU 604, DSP 606, NPU 608, and the like.

Generally, the processing system 600 and/or components thereof may be configured to perform the methods described herein.

Notably, in other aspects, elements of the processing system 600 may be omitted, such as where processing system 600 is a server computer or the like. For example, the multimedia component 610, wireless connectivity component 612, sensor processing units 616, ISPs 618, and/or navigation processor 620 may be omitted in other aspects. Further, elements of the processing system 600 may be distributed between multiple devices.

### Example Clauses

Implementation examples are described in the following numbered clauses:

Clause 1: A method, comprising: accessing a first feature tensor generated based on a model input to a machine learning model; generating a sampling matrix based on the model input; generating a first activation output, using a first activation layer of the machine learning model, based on the first feature tensor and the sampling matrix; and providing the first activation output as output from the first activation layer of the machine learning model.

Clause 2: A method according to Clause 1, wherein the sampling matrix is generated using a set of parameters having values learned during training of the machine learning model.

Clause 3: A method according to Clause 2, wherein the set of parameters corresponds to at least one of (i) an equivariant multilayer perceptron (MLP) or (ii) an equivariant convolutional layer.

Clause 4: A method according to any of Clauses 1-3, wherein the first feature tensor comprises Fourier coefficients generated by a first layer of the machine learning model and wherein the sampling matrix is used to perform an inverse Fourier transform operation on the first feature tensor.

Clause 5: A method according to any of Clauses 1-4, wherein the sampling matrix comprises a respective column for each respective irreducible representation (irrep) of a set of irreps of a transformation group to which the first activation layer of the machine learning model is equivariant.

Clause 6: A method according to any of Clauses 1-5, further comprising: generating a second feature tensor based on processing the first activation output using a second layer of the machine learning model; generating a downsampled sampling matrix based on processing the sampling matrix using a downsampling operation of the machine learning model; and generating a second activation output using a second activation layer of the machine learning model based on the second feature tensor and the downsampled sampling matrix.

Clause 7: A method according to Clause 6, wherein the downsampling operation comprises at least one of: (i) a linear interpolation operation or (ii) a convolution operation using one or more learned weights.

Clause 8: A method according to any of Clauses 1-7, further comprising generating a respective sampling matrix for each of a plurality of points in the model input, wherein the model input comprises point cloud data.

Clause 9: A method according to any of Clauses 1-8, wherein the activation output is generated according to

$$\tilde{f} ( x ) = \frac{1}{n} {A ( x )}^{T} σ ( A ( x ) \hat{f} ( x ) )$$

and wherein: \tilde{f}(x) is the activation output for the first feature tensor generated based on the model input, x is the model input, n indicates a number of rows in the sampling matrix, A(x) is the sampling matrix generated based on the first feature tensor, and \hat{f}(x) is the first feature tensor.

Clause 10: A processing system comprising: a memory comprising computer-executable instructions; and one or more processors configured to execute the computer-executable instructions and cause the processing system to perform a method in accordance with any of Clauses 1-9.

Clause 11: A processing system comprising means for performing a method in accordance with any of Clauses 1-9.

Clause 12: A non-transitory computer-readable medium comprising computer-executable instructions that, when executed by one or more processors of a processing system, cause the processing system to perform a method in accordance with any of Clauses 1-9.

Clause 13: A computer program product embodied on a computer-readable storage medium comprising code for performing a method in accordance with any of Clauses 1-9.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
one or more memories comprising processor-executable instructions; and
one or more processors configured to execute the processor-executable instructions and cause the processing system to:
access a first feature tensor generated based on a model input to a machine learning model;
generate a sampling matrix based on the model input;
generate a first activation output, using a first activation layer of the machine learning model, based on the first feature tensor and the sampling matrix; and
provide the first activation output as output from the first activation layer of the machine learning model.

2. The processing system of claim 1, wherein, to generate the sampling matrix, the one or more processors are configured to execute the processor-executable instructions and cause the processing system to use a set of parameters having values learned during training of the machine learning model.

3. The processing system of claim 2, wherein the set of parameters corresponds to at least one of (i) an equivariant multilayer perceptron (MLP) or (ii) an equivariant convolutional layer.

4. The processing system of claim 1, wherein the first feature tensor comprises Fourier coefficients generated by a first layer of the machine learning model and wherein the one or more processors are configured to further execute the processor-executable instructions to cause the processing system to use the sampling matrix to perform an inverse Fourier transform operation on the first feature tensor.

5. The processing system of claim 1, wherein the sampling matrix comprises a respective column for each respective irreducible representation (irrep) of a set of irreps of a transformation group to which the first activation layer of the machine learning model is equivariant.

6. The processing system of claim 1, wherein the one or more processors are configured to further execute the processor-executable instructions to cause the processing system to:
generate a second feature tensor based on processing the first activation output using a second layer of the machine learning model;
generate a downsampled sampling matrix based on processing the sampling matrix using a downsampling operation of the machine learning model; and
generate a second activation output, using a second activation layer of the machine learning model, based on the second feature tensor and the downsampled sampling matrix.

7. The processing system of claim 6, wherein the downsampling operation comprises at least one of: (i) a linear interpolation operation or (ii) a convolution operation using one or more learned weights.

8. The processing system of claim 1, wherein the one or more processors are configured to further execute the processor-executable instructions to cause the processing system to generate a respective sampling matrix for each of a plurality of points in the model input and wherein the model input comprises point cloud data.

9. The processing system of claim 1, wherein the activation output is generated
$$\tilde{f} ( x ) = \frac{1}{n} {A ( x )}^{T} σ ( A ( x ) \hat{f} ( x ) )$$
\tilde{f}(x) is the activation output for the first feature tensor generated based on the model input,
x is the model input,
n indicates a number of rows in the sampling matrix,
A(x) is the sampling matrix generated based on the first feature tensor, and
\hat{f}(x) is the first feature tensor.

10. A processor-implemented method, comprising:
accessing a first feature tensor generated based on a model input to a machine learning model;
generating a sampling matrix based on the model input;
generating a first activation output, using a first activation layer of the machine learning model, based on the first feature tensor and the sampling matrix; and
providing the first activation output as output from the first activation layer of the machine learning model.

11. The processor-implemented method of claim 10, wherein the sampling matrix is generated using a set of parameters having values learned during training of the machine learning model.

12. The processor-implemented method of claim 11, wherein the set of parameters corresponds to at least one of (i) an equivariant multilayer perceptron (MLP) or (ii) an equivariant convolutional layer.

13. The processor-implemented method of claim 10, wherein the first feature tensor comprises Fourier coefficients generated by a first layer of the machine learning model and wherein the sampling matrix is used to perform an inverse Fourier transform operation on the first feature tensor.

14. The processor-implemented method of claim 10, wherein the sampling matrix comprises a respective column for each respective irreducible representation (irrep) of a set of irreps of a transformation group to which the first activation layer of the machine learning model is equivariant.

15. The processor-implemented method of claim 10, further comprising:
generating a second feature tensor based on processing the first activation output using a second layer of the machine learning model;
generating a downsampled sampling matrix based on processing the sampling matrix using a downsampling operation of the machine learning model; and
generating a second activation output using a second activation layer of the machine learning model based on the second feature tensor and the downsampled sampling matrix.

16. The processor-implemented method of claim 15, wherein the downsampling operation comprises at least one of: (i) a linear interpolation operation or (ii) a convolution operation using one or more learned weights.

17. The processor-implemented method of claim 10, further comprising generating a respective sampling matrix for each of a plurality of points in the model input, wherein the model input comprises point cloud data.

18. The processor-implemented method of claim 10, wherein the activation output is generated according to
$$\tilde{f} ( x ) = \frac{1}{n} {A ( x )}^{T} σ ( A ( x ) \hat{f} ( x ) )$$
and wherein:
\tilde{f}(x) is the activation output for the first feature tensor generated based on the model input,
x is the model input,
n indicates a number of rows in the sampling matrix,
A(x) is the sampling matrix generated based on the first feature tensor, and
\tilde{f}(x) is the first feature tensor.

19. One or more non-transitory computer-readable media comprising processor-executable instructions that, when executed by one or more processors of a processing system, cause the processing system to:
access a first feature tensor generated based on a model input to a machine learning model;
generate a sampling matrix based on the model input;
generate a first activation output, using a first activation layer of the machine learning model, based on the first feature tensor and the sampling matrix; and
provide the first activation output as output from the first activation layer of the machine learning model.

20. The non-transitory computer-readable media of claim 19, wherein the sampling matrix is generated using a set of parameters having values learned during training of the machine learning model.

21. The non-transitory computer-readable media of claim 20, wherein the set of parameters corresponds to at least one of (i) an equivariant multilayer perceptron (MLP) or (ii) an equivariant convolutional layer.

22. The non-transitory computer-readable media of claim 19, wherein the first feature tensor comprises Fourier coefficients generated by a first layer of the machine learning model and wherein the sampling matrix is used to perform an inverse Fourier transform operation on the first feature tensor.

23. The non-transitory computer-readable media of claim 19, wherein the sampling matrix comprises a respective column for each respective irreducible representation (irrep) of a set of irreps of a transformation group to which the first activation layer of the machine learning model is equivariant.

24. The non-transitory computer-readable media of claim 19, wherein the one or more processors are configured to further execute the processor-executable instructions to cause the processing system to:
generate a second feature tensor based on processing the first activation output using a second layer of the machine learning model;
generate a downsampled sampling matrix based on processing the sampling matrix using a downsampling operation of the machine learning model; and
generate a second activation output, using a second activation layer of the machine learning model, based on the second feature tensor and the downsampled sampling matrix.

25. The non-transitory computer-readable media of claim 24, wherein the downsampling operation comprises at least one of: (i) a linear interpolation operation or (ii) a convolution operation using one or more learned weights.

26. The non-transitory computer-readable media of claim 19, wherein the one or more processors are configured to further execute the processor-executable instructions to cause the processing system to generate a respective sampling matrix for each of a plurality of points in the model input and wherein the model input comprises point cloud data.

27. The non-transitory computer-readable media of claim 19, wherein the activation output is generated according to
$$\tilde{f} ( x ) = \frac{1}{n} {A ( x )}^{T} σ ( A ( x ) \hat{f} ( x ) )$$
and wherein:
\tilde{f}(x) is the activation output for the first feature tensor generated based on the model input,
x is the model input,
n indicates a number of rows in the sampling matrix,
A(x) is the sampling matrix generated based on the first feature tensor, and
\tilde{f}(x) is the first feature tensor.

28. A processing system, comprising:
means for accessing a feature tensor generated based on a model input to a machine learning model;
means for generating a sampling matrix based on the model input;
means for generating an activation output, using an activation layer of the machine learning model, based on the feature tensor and the sampling matrix; and
means for providing the activation output as output from the activation layer of the machine learning model.

29. The processing system of claim 28, wherein the sampling matrix is generated using a set of parameters having values learned during training of the machine learning model to generate the sampling matrix.

30. The processing system of claim 28, wherein the activation output is generated according to
$$\tilde{f} ( x ) = \frac{1}{n} {A ( x )}^{T} σ ( A ( x ) \hat{f} ( x ) )$$
and wherein:
\tilde{f}(x) is the activation output for the feature tensor generated based on the model input,
x is the model input,
n indicates a number of rows in the sampling matrix,
A(x) is the sampling matrix generated based on the feature tensor, and
\hat{f}(x) is the feature tensor.
